(19) United States
(12) Patent Application Publication
(10) Pub. No.: US 2022/0061419 A1
(43) Pub. Date: Mar. 3, 2022

(54) CUSTOM DESIGNED FACE MASK AND KIT

(71) Applicant: AMY NICKLAUS, Randolph, NJ (US)

(72) Inventor: AMY NICKLAUS, Randolph, NJ (US)

(21) Appl. No.: 17/093,199

(22) Filed: Nov. 9, 2020

Related U.S. Application Data
(60) Provisional application No. 63/072,559, filed on Aug. 31, 2020.

(51) Int. Cl. A41D 13/11

(52) U.S. Cl. CPC A41D 13/1107

(57) ABSTRACT

A custom designed face mask and kit. The custom designed face mask can be formed of a material which is suitable to enable ink to be readily adhered without bleeding. A design, indicia or pattern can be printed on the material of the custom designed face mask. The kit can include one or more pens having non-bleed ink.

### BACKGROUND OF THE INVENTION

### Field of the Invention

The present invention relates to a mask which can be custom designed by a user and kit therefor.

### Description of the Related Art

It has been found that certain viruses can be disseminated rapidly from person to person to result in widespread community transmission. In addition, some people may be asymptomatic carriers in which they are carriers of the infection without having symptoms of the disease. The asymptomatic carriers can infect other people without even knowing they are causing substantial amounts of infection. For example, there has been widespread transmission of disease during the recent pandemic due to the coronavirus SARS-CoV-2 which is responsible for coronavirus disease 2019 or COVID-19. To protect against pathogens people may wear various accessories such as face masks and shields.

Conventional masks are made of fabric or paper materials. The conventional mask may come in a particular color or have standard writing or a logo such as for a particular organization or team. However, the conventional masks have little creativity for a wearer to express themselves or provide a unique design. In addition, children needing to wear masks may be uninterested, uncomfortable or feel scared. It is desirable to provide a custom designed face mask and kit to allow a user to readily customize the face mask into a unique design which provides interest for all ages and comfort of anxiety of children to make them feel more comfortable by wearing a customized face mask which they designed.

### SUMMARY OF THE INVENTION

The present invention relates to a custom designed face mask and kit. The custom designed face mask can be formed of a material which is suitable to enable ink to be readily adhered. In one embodiment, the custom designed face mask is formed of a non-bleed material. The material for the custom designed face mask can also be breathable. Suitable materials for masks include a cotton blend. In one embodiment, the material is a 70/30 two ply cotton and polyester blend making it both breathable and so that the markers do not bleed when coloring. A soft and stretchy lining material can be formed on an inner surface of the custom designed face mask. Adjustable straps can be coupled or adhered to each side of the custom designed face mask. The custom designed face mask can include a pinchable bridge. The custom designed face mask can have an appropriate size of a child or of an adult. A design, indicia or pattern can be printed on the material of the custom designed face mask.

In one embodiment, the kit can include one or more pens having no-bleed ink which is non-toxic. For example, the pens can be thin tipped water color pens. For example, each of the water color pens can be of a different color selected from for example, black, red, orange, yellow, green, blue, royal blue, wathet, grey, lilac, pink, light rose red, dark green, blackish green and light brown. In one embodiment, a kit includes one or more face masks. Some embodiments of the kit can include a theme for the custom designed face masks such as for example, name tags, days of the week, feelings, numbers, animals, dinosaurs, sports, outer space, princesses, construction, garden, puzzles and patterns. The design, indicia, or pattern printed on the custom designed face mask can be related to the theme. The kit provides a fun activity for children to customize a personal face mask. The kit can be distributed to students of a class room. The invention will be more fully described by reference to the following drawings.

### BRIEF DESCRIPTION OF THE DRAWINGS

FIGS. 1A-1C are schematic diagrams of a custom designed face mask in accordance with the teachings of the present invention.

FIGS. 2A-2B are schematic diagrams of a kit of the custom designed face mask.

FIGS. 3A-3M are schematic diagrams of custom designed face masks.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

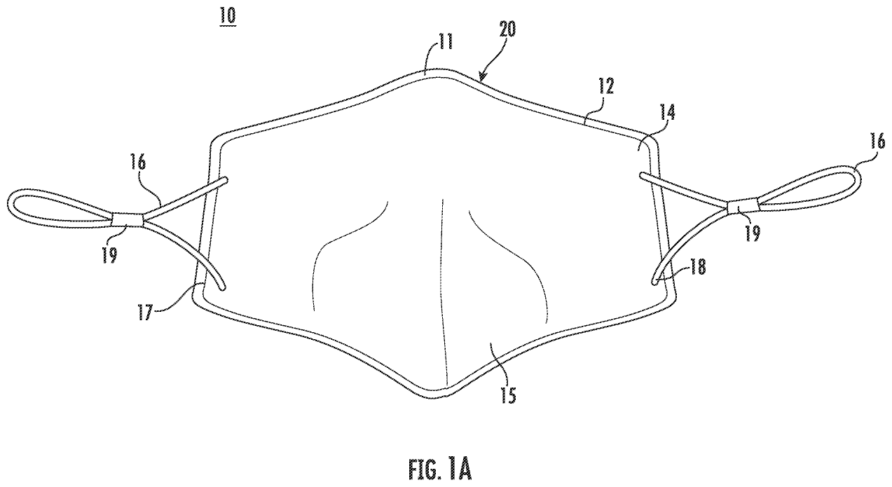

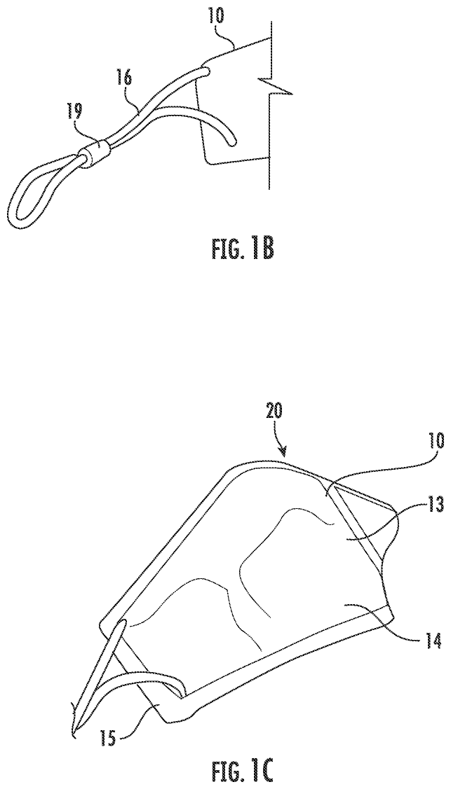

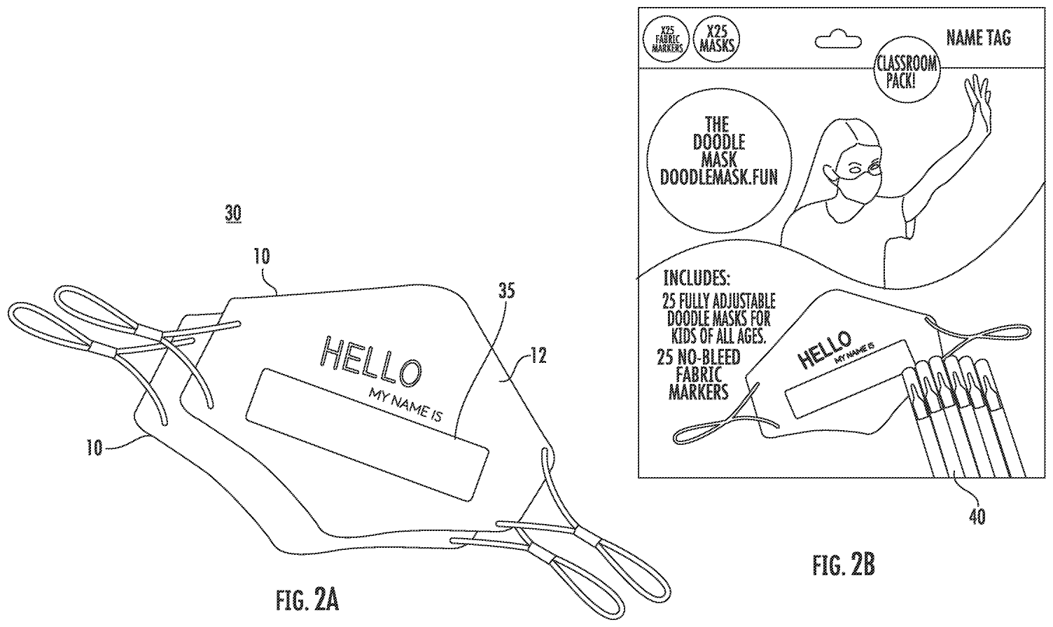

FIGS. 1A-1C are schematic diagrams of custom designed face mask 10 in accordance with the teaching of the present invention. Custom designed face mask 10 includes body can be formed of material 12. Material 12 is formed of a suitable material to enable ink to be readily adhered. Material 12 can be a non-bleed material. Material 12 can be a breathable material. Suitable materials 12 include a cotton blend. In one embodiment, material 12 is a cotton polyester blend. Suitable materials for masks include a cotton blend. In one embodiment, material 12 is a 70/30 two ply cotton and polyester blend. Material 12 can be reusable and washable. Pinchable bridge 11 can be positioned at upper portion of custom designed face mask 10. Pinchable bridge 11 can be used for pinching the nose when in use. For example, pinchable bridge 11 can be formed of metal.

Inner lining 14 can be adhered or coupled to inner surface 13 of custom designed face mask 10. Inner lining 14 can be formed of a soft and stretchy lining material. For example, inner lining 14 can be formed of a knitted fabric or elastic synthetic material. In one embodiment, inner lining 14 is formed of spandex or blends of spandex with cotton or polyester. Inner lining 14 can be sewn to outer surface 15. Pinchable bridge 11 can be positioned or sewn between inner lining 14 and outer surface 15.

Adjustable straps 16 can be coupled or adhered to each side 17, 18 of custom designed face mask 10. Adjustment coupling 19 can be used for adjusting the size of adjustable straps 12.

Body 20 is formed of inner lining 14 and outer surface 15. In one embodiment, inner lining 14 and outer surface 15 are integral. In one embodiment, custom designed face mask 10 can have an appropriate size of body 20 and adjustable straps 16 to fit a face of a child. Alternatively, custom designed face mask 10 can have an appropriate size of body 20 and adjustable straps 16 to fit a face of an adult.

Kit 30 can include one or more custom designed face masks 10 and one or more pens 40. Pens 40 can be used to write on or color outer surface 15. Pens 40 can contain non-bleed ink to be used on fabric. Pens 40 can be non-toxic. Pens 40 can have a thin tip. For example, pens 40 can be water color pens of a different color selected from, for example, black, red, orange, yellow, green, blue, royal blue, wathet, grey, lilac, pink, light rose red, dark green, blackish green and light brown. Pens 40 can be anti-flammable and safe for use by children. A design, indicia or pattern 35 can be printed on material 12 of custom designed face mask 10.

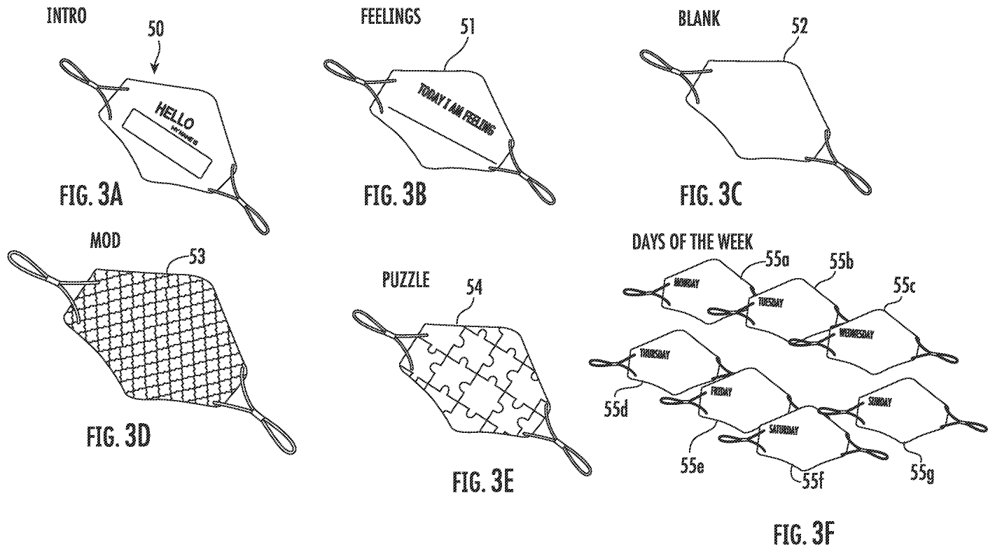

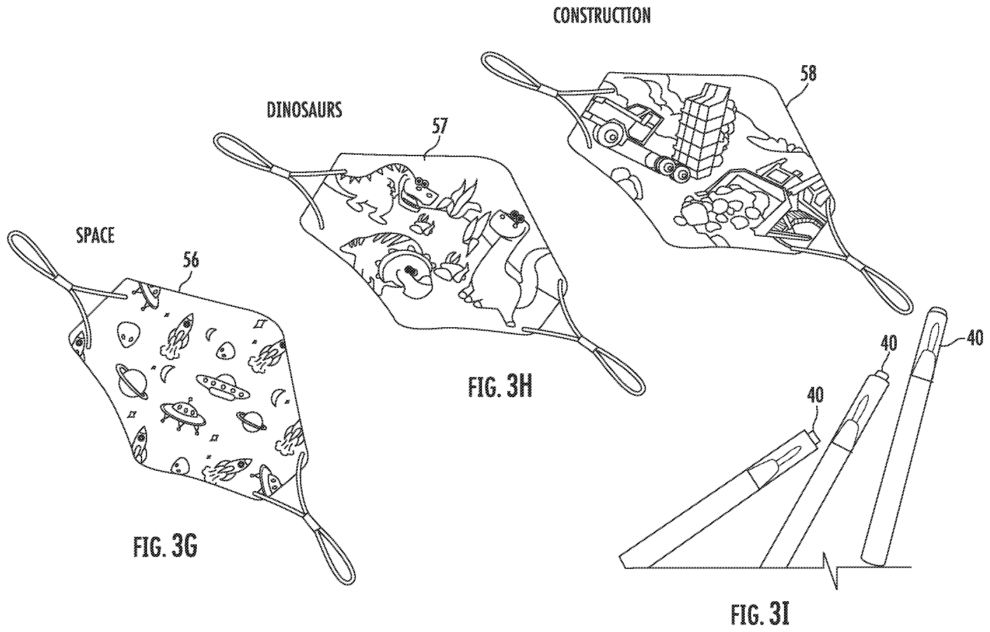

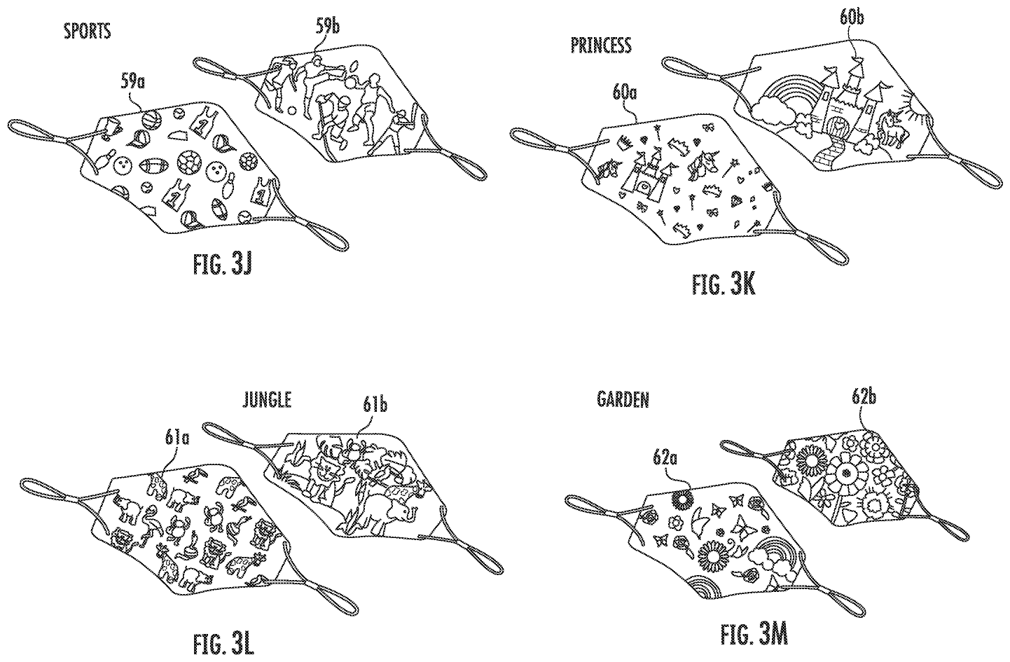

Examples of design, indicia or pattern 35 can be printed on material 12 of custom designed face mask 10 as shown in FIGS. 3A-3M. Some embodiments of kit 30 can include a theme for custom design face masks 10. FIG. 3A illustrates an example theme of name tags including name tag indicia 50. FIG. 3B illustrates an example theme of feelings including feeling indicia 51. FIG. 3C illustrates an example theme of blank 52 to allow the user to create their own design. FIG. 3D illustrates an example theme of a pattern including pattern 53. FIG. 3E illustrates an example theme of a puzzle including puzzle design 54. FIG. 3F illustrates an example theme of days of the week including days of the week indicia 55a-55g. FIG. 3G illustrates an example theme of space including space design 56. FIG. 3H illustrates an example theme of dinosaurs including dinosaurs design 57. FIG. 3I illustrates an example theme of construction including construction design 58. FIG. 3J illustrates an example theme of sports including sports designs 59a, 59b. FIG. 3K illustrates an example theme of a princess including princess design 60a, 60b. FIG. 3L illustrates an example theme of a jungle including jungle designs 61a,61b. FIG. 3M illustrates an example theme of a garden including gardens designs 62a,62b. One or more pens 40 can be used to color design, indicia or pattern 35 to customize custom designed face mask 10.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed:

1. A custom designed face mask comprising:
a body, the body being formed of a non-bleed material to receive ink; and
a strap coupled to each side of the body.

2. The custom designed face mask of claim 1 wherein the body includes a design, indicia or pattern on an outer surface of the body, wherein the design, indicia or pattern is configured to receive the ink.

3. The custom designed face mask of claim 1 wherein the non-bleed material is a cotton blend.

4. The custom designed face mask of claim 1 wherein the non-bleed material is a 70/30 two ply cotton and polyester blend.

5. The custom designed face mask of claim 1 wherein the body includes an outer surface coupled to an inner lining.

6. The custom designed face mask of claim 5 wherein the inner lining is formed of an elastic synthetic material, blend of an elastic synthetic material and cotton or blend of an elastic synthetic material and polyester.

7. The customed designed face mask of claim 1 wherein a pinchable bridge is coupled to an upper portion of the body.

8. The customed designed face mask of claim 1 wherein the strap coupled to each side of the body is adjustable.

9. The custom designed face mask of claim 1 wherein an outer surface of the body includes indicia of a name tag, day of the week, feeling, one or more numbers, one or more animals, one or more dinosaurs, one or more sports, one or more outer space items, one or more princesses, one or more construction items, one or more garden items, one or more puzzles or one or more patterns.

10. A kit for a custom designed face mask comprising:
a custom designed face mask, the custom designed face mask including a body, the body being formed of a non-bleed material to receive ink, and
a strap coupled to each side of the body; and
at least one pen to write on or color an outer surface of the body.

11. The kit of claim 10 wherein the body includes a design, indicia or pattern on an outer surface of the body, wherein the design, indicia or pattern is configured to receive the ink.

12. The kit of claim 10 wherein the non-bleed material is a cotton blend.

13. The kit of claim 10 wherein the non-bleed material is a 70/30 two ply cotton and polyester blend.

14. The kit of claim 10 wherein the body includes an outer surface coupled to an inner lining.

15. The kit of claim 14 wherein the inner lining is a material is formed of an elastic synthetic material, blend of an elastic synthetic material and cotton or blend of an elastic synthetic material and polyester.

16. The kit of claim 10 wherein a pinchable bridge is coupled to an upper portion of the body.

17. The kit of claim 10 wherein the strap coupled to each side of the body is adjustable.

18. The kit of claim 10 comprising a plurality of the custom designed face masks, the outer surface of the body of each of the plurality of custom designed face makes includes indicia of a theme selected from the group consisting of name tags, days of the week, feelings, numbers, animals, dinosaurs, sports, outer space, princesses, construction, garden, puzzles and patterns.

19. The kit of claim 10 comprising a plurality of the pens, each of the pens having a different color ink.

20. The kit of claim 10 wherein the one or more pens contain non-bleeding ink.
